(19) United States
(12) Patent Application Publication
(10) Pub. No.: US 2008/0154802 A1
(43) Pub. Date: Jun. 26, 2008

(54) Utility product usage internet access

(76) Inventors: Larry K. Chalupsky, East Gull Lake, MN (US); Josh Headlee, Coon Rapids, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/998,462

(22) Filed: Nov. 28, 2007

Related U.S. Application Data
(60) Provisional application No. 60/861,766, filed on Nov. 29, 2006.

(51) Int. Cl. G06F 17/00

(52) U.S. Cl. 705/412

(57) ABSTRACT

A method for providing additional information to utility product users based on an assemblage of utility product consumption data and utility product consumption billing of users data supplied to obtain corresponding billing payments by obtaining current utility product consumption data and determining current user charges to be billed to users for the current utility product consumed. In addition, the method further comprises obtaining previous utility product consumption data from a data storage facility and also obtaining corresponding previous charges determined therefor. Thereafter, the method proceeds by presenting to corresponding users over a computer network the current utility product consumption data, the current charges, the previous utility product consumption data and the previous charges.

### CROSS-REFERENCE TO RELATED APPLICATION

This application claims the benefit of Provisional Patent Application No. 60/861,766 filed Nov. 28, 2006 for ELECTRICAL ENERGY USAGE INTERNET ACCESS.

### BACKGROUND

The present invention relates to a method and apparatus for obtaining consumption data at user sites from utility business metering systems indicating the amount of the utility product consumed for transmission to both the users and the providing utility business as a basis for the utility business billing such users along with the corresponding capability for the users to effect payment thereof and, more particularly, using such an arrangement for additionally providing transmission to users of previous utility product usage and billings information along with indications of how future usage and billings therefor can be reduced.

The costs of obtaining user utility product consumption data measured by appropriate meters at the site at which the user consumes same has been decreasing through the use of metering systems having meters therein that can transmit such data to a more central repository. Such metering systems eliminate, or much reduce, the need for human operatives to record and assemble such consumption data.

In addition, multiple utility product meters are often provided at user sites to measure both (a) the overall consumption of the utility product at the site through use of an overall meter and (b) the consumption of the utility product by individual using devices located at that site as a fraction of the overall usage through the use of submeters. These multiple meter arrangements at user sites allow the possibility of billing for utility product consumption at different billing rates for consumption by different using devices or for consumption by those devices at different times during selected time durations. Thus, as an example, there could be an overall electrical power consumption meter at a residential house measuring overall consumption of the electrical power supplied by the utility there and a submeter measuring consumption of the electrical power supplied by the utility there for an air conditioner. Such metering systems are often accompanied by a control arrangement allowing the utility to interrupt or reduce the amount of utility product being consumed at the user site for selected time durations by certain of the utility product consuming devices there.

The utility product consumption data received by the utility at the more central repository is then used to prepare appropriate billings for users, and such billings can be transmitted and presented to the corresponding users over computer network arrangements such as the Internet. Correspondingly, the users can effect payment of those bills through one of the payment systems available in such computer network arrangements usually through the Internet. Although these metering systems, billing arrangements and payment arrangements are effective, there remains a desire to reduce the costs thereof and to enhance the information available to users.

### SUMMARY

The present invention provides a method for providing additional information to utility product users based on an assemblage of utility product consumption data and utility product consumption billing of users data supplied to obtain corresponding billing payments. The method comprises obtaining current utility product consumption data for the utility product consumed at corresponding user sites during a now past selected time duration from utility product consumption meters located at those user sites and determining current user charges to be billed to users for the current utility product consumed at corresponding those user sites during the now past selected time duration. In addition, the method further comprises obtaining previous utility product consumption data for the utility product consumed at corresponding user sites during at least one previous selected time duration occurring prior to the now past selected time duration, and which is obtained from a data storage facility storing therein utility product consumption data previously obtained from utility product consumption meters located at corresponding those user sites and also obtaining corresponding previous charges determined therefor. Thereafter, the method proceeds by presenting to corresponding users over a computer network the current utility product consumption data, the current charges, the previous utility product consumption data and the previous charges.

### BRIEF DESCRIPTION OF THE DRAWINGS

FIGS. 1 and 2 show data flow diagrams embodying the present invention.

### DETAILED DESCRIPTION

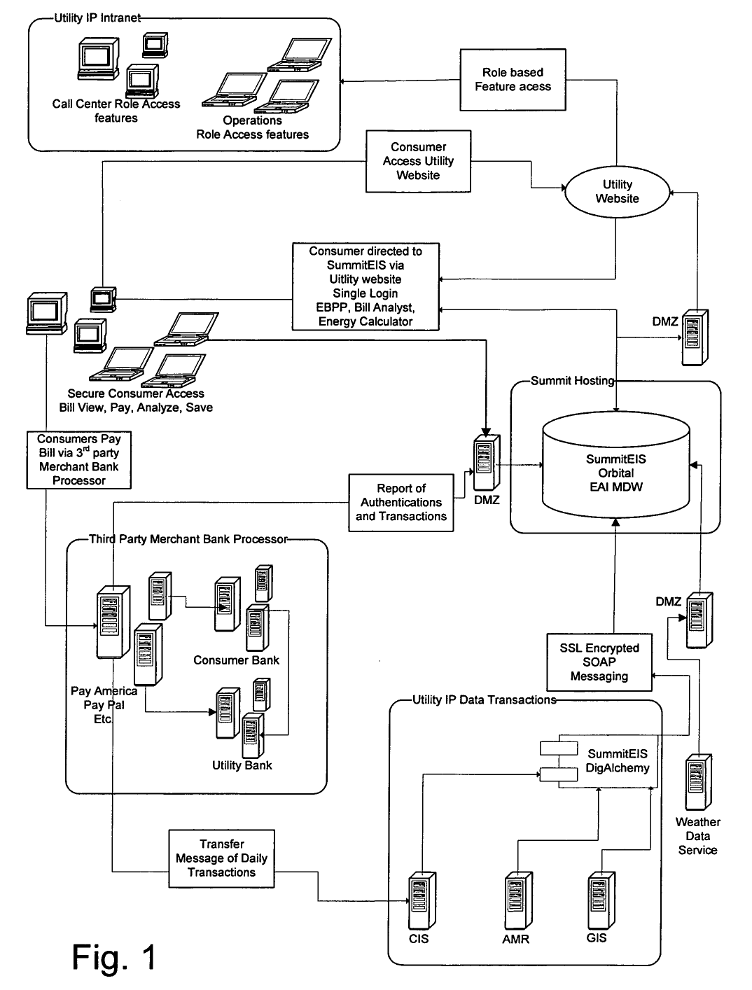

The present invention provides a web portal application that gas, water or electrical energy utility companies can use, through their Internet websites, to provide their customers the opportunity to view, pay, and analyze their bills for electrical energy provided to them. FIG. 1 shows a data flow chart indicating the manner in which these opportunities are provided

The equipment used in implementing this Internet based service includes a SummitPAS Orbital which is a secure transactional Enterprise Application Interface and data warehouse that obtains the data messages from different data stores. Manages, validates, and estimates where required to allow the consumer to view their information. Both the SummitPAS and Orbital are located in managed Hosting facilities that the utility operates. All of the messaging between the data stores are secure SSL SOAP web service messaging except for the Billing Cycle print Document file that is obtained to produce the Bill View image that comes across a FTP connection into the utility servers.

The SummitPAS DigAlchemy is an application that resides within the firewall used by the utility company. This application collects the information from the different utility company data stores and encrypts the messages and transfers these messages to the SummitPAS Orbital application via SOAP internet messaging. This application is operated on a schedule to check data changes in each of the stores and update the MSP servers as required.

Four main data transfer and management objects are shown within FIG. 1. They include the following:
Utility Data Store
NOAA weather station data
Third Party Merchant Bank Processor
SummitPAS Orbital tm Meter Data Warehouse and Enterprise application Interface

Three main processing components that are present in the data flow chart of FIG. 1. The Utility Data Information Store. The utility would be a gas, water, or electrical utility company. This company could be a Municipal utility, Cooperative utility, or an Investor Utility. These Utilities have data systems that store the information that w use to display to their consumer.

The first of these datasets is the CIS or customer information system. This could also be referred to as the billing or financial system. The data value in this system is the personal information on each consumer that helps identify, relate, and personalize the information store for presentation and for integration to the other data stores. This data store also contains information on the historical billing and historical billing charges that are required for displaying with the bill analysis portion of the web application.

The second data store is the AMR Automated Meter Reading system at the Utility. This system measures and collects energy consumption data on a daily basis at the consumer's residence and is communicated to the utility primarily for billing purposes. We will use the data to enable the consumer to see their daily energy consumption and daily energy cost as it relates to their monthly or interval billing.

The last data store from the Utility is the Geographic Information System GIS. This information collects the sectionalizing information about the consumer location that relates to the distribution capacity and quality of the distribution network that hauls the energy components to the residential or commercial locations.

The National Oceanic & Atmospheric Administration weather service is a national grid of weather data collection sites that read weather information at hourly intervals. The utility establishes a secure link between it and the NOAA web service connectors to SummitPAS Orbital EAI data warehouse.

Electronic payment activities are handled through a third party Merchant Bank processor that accepts the payment from the consumer via the SummitPAS interface and manages the consumer bank to Utility bank transaction. This Third party Merchant bank submits a web service message to the Summit Orbital warehouse of the authorization of the transaction and then presents this on the SummitPAS web page as a validation to the consumer of the transaction. The Merchant Bank processor at the end of the day compiles the list of bank transactions and submits a web service file of these transactions to the Utility CIS or billing/financial system to update the records for their accounting day end closings.

The SummitPAS Orbital Meter Data Warehouse and Enterprise application interface manages and stores the web service messages from the different sources stores, allocates, runs validation and estimazation where required, and presents the data via the utility web application.

Customers, or consumers, start accessing the information from the utility Internet web site. SummitPAS is an integrated web product to utility websites. The consumers are directed to the SummitPAS URL from the Utility Web site to view, pay and analyze their energy bills. The consumer is aware that they are At SummitPAS rather than the utility site by the presence of the SummitPAS logo on each screen, The SummitPAS url address, and the disclaimer note on the site that explains to them the process of the transactions. The consumer pays their bill through the third party Merchant bank processor via an encrypted web service message link from the SummitPAS to the Third party Merchant bank processor. The consumer receives a message authorizing the payment that is transmitted from the Third party Merchant Bank to the Orbital Warehouse and then presented on the SummitPAS Pay screen. The consumer is able to see their energy bill and bill history through the SummitPAS Analyze screen from a data transaction process that starts at the DigAlchemy program that resides at the Utility Data store.

The consumer via the management and presentation of the data via the Orbital data warehouse passes to SummitPAS the required information.

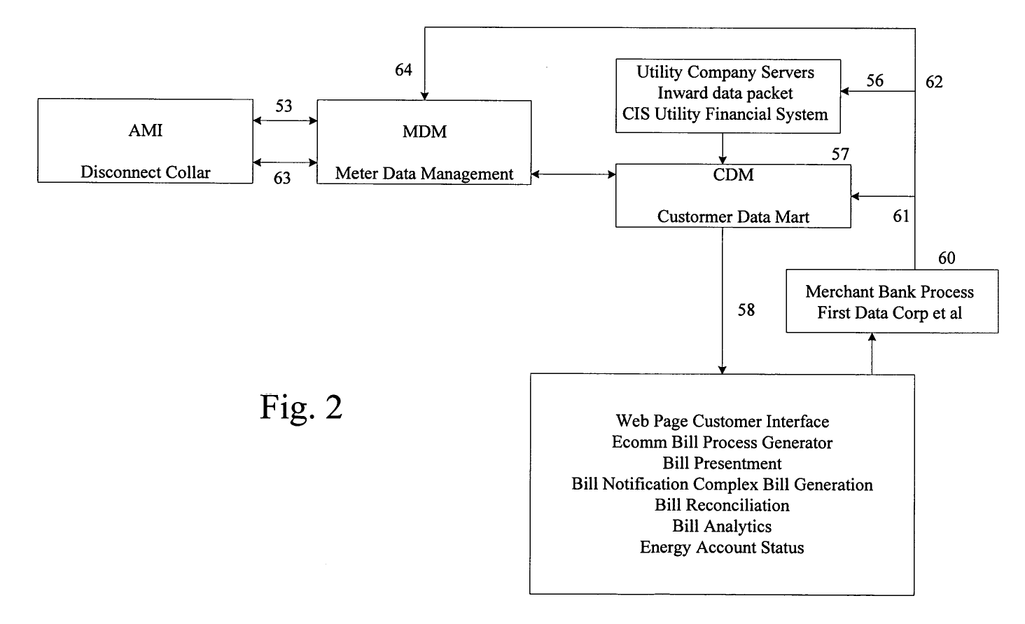

FIG. 2 represents the bill payment prepayment notification process and shows the data flows, aggregation, and notification process for the automated meter infrastructure (AMI) metering payment feature of the system. (57) Data from the utility account information system integrates data records for accounts, physical meter locations and associated meter identification and historical meter locations at customer sites. The readout value of the previous meter in case of meter removals and movement of them among user locations in the system allows the meter data management (64) to retain the interval data to the meter-location-time value. As typical meter systems only record the readings as a meter-reading-time relationship, but the meter data management (MDM) storage facility maintains a record of customer-location site-meter-reading-time relationship. This is needed so that the load profiles of the customer can be tracked even if a meter is physically moved to another customer site or if an existing customer moves to a new location. This is needed as algorithms for validating missing readouts can be more accurately ascertained when readings for a customer are contiguous and as customer energy consumption patterns differ at different locations. (55) Inputs data from the MDM to ensure data integrity to the customer account information, or customer market information, i.e. the customer data mart (CDM). The CDM maintains the logon authentication of the web presentation for both utility users as well as the customers of the energy utility. (58) The web interface provided by the Web Page Customer Interface, as a secure and encrypted internet application, notifies customers of their bill and energy use. It allows customers to check on the status of their usage account and allows the customer the ability to add money to their account or pay for the utility product consumed. This site allows the customer to view historical energy bills and compare their bills as well as analyze their bill bases. The ability to relate their energy bills to the energy consumption at intervals as little as hourly as it correlates to weather variables as well as control variables also referred to as demand response or time of use metering. The customer is allowed to set notification schedules concerning their energy consumption or their account balance so as not to use energy unexpected or become delinquent in paying for their service. Lastly the service allows the customer to perform energy saving routines. It allows the customer to analyze 6 categories of energy consumption from heating, cooling, lighting, appliance use, well pumps, water heating, other at any meter reading interval. (60) The customer payment is processed in a standard third party Merchant bank service such as First Data Corp that transmits the bank routing information and sends authentication receipts to the CDM which establishes a data input on schedule to the utility CIS Financials system (62) (61) for reporting purposes. (63) Authentication or transaction message is also input into MDM to credit account in Pre-payment features and identified as an increase in usable energy to customer and presented to the web as a credit (59).

Although the present invention has been described with reference to preferred embodiments, workers skilled in the art will recognize that changes may be made in form and detail without departing from the spirit and scope of the invention.

1. A method for providing additional information to utility product users based on an assemblage of utility product consumption data and utility product consumption billing of users data supplied to obtain corresponding billing payments, said method comprising:
obtaining current utility product consumption data for said utility product consumed at corresponding user sites during a now past selected time duration from utility product consumption meters located at said user sites,
determining current user charges to be billed to users for said current utility product consumed at corresponding said user sites during said now past selected time duration,
obtaining previous utility product consumption data for said utility product consumed at corresponding said user sites, during at least one previous selected time duration occurring prior to said now past selected time duration, from a data storage facility storing therein utility product consumption data previously obtained from utility product consumption meters located at corresponding said user sites and obtaining corresponding previous charges determined therefor, and
presenting to corresponding users over a computer network said current utility product consumption data, said current charges, said previous utility product consumption data and said previous charges.
